(19) United States
(12) Patent Application Publication
(10) Pub. No.: US 2026/0158434 A1
(43) Pub. Date: Jun. 11, 2026

(54) POLYMER-METAL ORGANIC FRAMEWORK COMPOSITES AND METHODS OF CAPTURING CO2

(71) Applicant: University of Virginia Patent Foundation, Charlottesville, VA (US)

(72) Inventors: Gaurav GIRI, Charlottesville, VA (US); Prince Kumar VERMA, Charlottesville, VA (US); Geoffrey M. GEISE, Charlottesville, VA (US); Andres F. CLARENS, Charlottesville, VA (US); Hailey Elizabeth HALL, Charlottesville, VA (US)

(21) Appl. No.: 19/150,114

(22) PCT Filed: Jan. 29, 2024
(86) PCT No.: PCT/US2024/013320

§ 371 Date: Jul. 22, 2025

Related U.S. Application Data
(60) Provisional application No. 63/442,076, filed on Jan. 30, 2023.

(51) Int. Cl. B01D 53/14; B01D 53/04; B01J 31/16; B01J 31/22

(52) U.S. Cl. CPC B01D 53/1475; B01D 53/04; B01J 31/1633; B01J 31/22; B01D 2252/204; B01D 2257/504; B01D 2258/06

(57) ABSTRACT

The present disclosure provides for polymer-MOF composites, methods of making polymer-MOF composites, methods of capturing CO₂, direct air capture devices and systems that include the polymer-MOF composites, and the like. The polymer-MOF composites of the present disclosure can include polymers that are 100 k Daltons or more or 500 k Daltons or more within the pores of the MOF.

### CROSS-REFERENCE TO RELATED APPLICATIONS

This application claims priority to U.S. provisional application entitled “Enhancing Polymers for Carbon Capture Using Metal Organic Frameworks as Cages” having Ser. No. 63/442,076 filed on Jan. 30, 2023, which is entirely incorporated herein by reference.

### BACKGROUND

The target proposed by the Carbon Negative Shot requires a fundamental shift in the development of materials for CO₂ capture and storage. Just the development of materials that can adsorb large quantities of CO₂ is not enough; these materials need to be easily integrated into systems, last through multiple regeneration cycles, and be able to be produced cheaply and in bulk quantities.

### SUMMARY

Embodiments of the present disclosure provide for polymer-MOF composites, methods of making polymer-MOF composites, methods of capturing CO₂, direct air capture devices and systems that include the polymer-MOF composites, and the like.

The present disclosure provides for a polymer-metal organic framework (polymer-MOF) composite, comprising: a polymer entrapped within pores of a metal organic framework (MOF), wherein the MOF is formed from precursor materials, wherein the polymer has a molecular weight of about 30 k Daltons to 3,000,000 Daltons, wherein the polymer and precursor materials that are used to form the MOF are each miscible within a first solvent, wherein the polymer-MOF composite is stable in the first solvent for about 24 hours or more, wherein the polymer-MOF composite is thermally stable at about 100 to 120° C., and wherein the polymer-MOF composite has the absorption capacity of about 2 to 14 mmol/gram of polymer-MOF composite of CO₂. In an aspect, the polymer can be selected from the group consisting of: a polyacrylamide, poly(N-isopropylacrylamide) (PNiPAM), poly(2-ethyl-2-oxazoline), polycaprolactam, poly(2-ethyl-2-oxazoline), poly(acrylamide/acrylic acid), polyacrylamide, poly(N-vinylpyrrolidone), poly(allylamine), polyethylenimine, polypropylenimine, polyvinylamine, poly(4-aminostyrene), poly(N-methylvinylamine), poly(diallyldimethylammonium chloride), poly(2-vinyl-1-methylpyridinium bromide), chitosan, poly(l-lysine hydrobromide), poly(L-lysine), polyaniline, and ploly (N-acryloyl gylcinamine).

The present disclosure provides for a polymer-metal organic framework (polymer-MOF) composite, comprising: a polymer entrapped within pores of a metal organic framework (MOF), wherein the MOF is made of precursor materials, wherein the polymer has a molecular weight of about 30 k Daltons to 3,000,000 Daltons, wherein the polymer and the precursor materials that form the MOF are each miscible within a first solvent, wherein the polymer-MOF composite is stable in the first solvent for about 24 hours or more, and wherein the polymer-MOF composite is thermally stable at about 100 to 120° C.

The present disclosure provides for a direct air capture (DAC) system, comprising a CO₂ capture element, wherein the CO₂ capture element includes the polymer-MOF composite as described above and herein.

The present disclosure provides for a method of removing CO₂ from a gas, comprising: exposing the polymer-MOF composite of any of claims 1 to 10 to the gas, wherein CO₂ is captured by the polymer-MOF composite; and removing the CO₂ from the polymer-MOF composite by exposing the polymer-MOF composite to water, wherein the CO₂ is released into water to renew the polymer-MOF composite.

### BRIEF DESCRIPTION OF DRAWINGS

Further aspects of the present disclosure will be more readily appreciated upon review of the detailed description of its various embodiments, described below, when taken in conjunction with the accompanying drawings.

FIG. 1.1 illustrates the polymer-MOF formation concept. The UiO-66-NH₂ MOF crystals grow around the polyethyleneimine (PEI) polymer, so that the chain is trapped within the MOF. If the polymer is long or branched, it is possible for multiple MOF crystals to form around the polymer chain. The polymer chains can also be solvated or extended, providing an opportunity to change the composite properties as a function of the environmental conditions. The chosen polymer PEI has shown carbon dioxide capture and direct air capture (DAC) capability.

FIG. 1.2 illustrates the concept of a moisture swing adsorption for a tertiary aminated polymer for capture and release of CO₂.¹ At low humidity (in air), CO₂ adsorbs to form a bicarbonate ion, while at high humidity (in water), CO₂ desorbs and a hydroxyl ion is adsorbed.

FIG. 1.3(a) illustrates scanning electron micrograph image of 74 wt % UiO-66 MOF 26 wt % PEI polymer composite, scalebar is 10 microns. Elemental distribution shows Zr and N presence, for UiO-66 and PEI respectively. FIG. 1.3(b) illustrate X-ray diffraction of various polymer-MOF composite wt % show the formation of UiO-66-NH₂ in a wide range (all legends MOF wt %). FIG. 1.3(c) illustrates BET scan of a 74 wt % UiO-66 MOF-NH₂ 26 wt % PEI polymer composite, before CO₂ capture, and after one round of CO₂ capture, release and regeneration. High surface area is preserved (˜300 m²/g). FIG. 1.3 (d) illustrates CO₂ capture capacity of various composites, some of these composites showing higher capture ability than most solid sorbents previously published.

FIG. 1.4 illustrates water-based release of CO₂ from various compositions of UiO-66-NH₂/PEI polymer-MOFs. An optimal concentration of polymers inside the MOF exists to obtain high CO₂ loading capacity. CO₂ is released when the composite is immersed in water within minutes. The 100 wt % PEI control (not shown) shows no change in CO₂ concentration in the headspace.

FIG. 2.1 illustrates that after creating UiO-66-NH₂, the solution was filter dried to isolate the MOF. Using water-based release, the capture capacity was measured. After submerging the sample in water to release the CO₂, which was measured here by a handheld CO₂ monitor (data shown FIG. 2.1), the sample was dried again. The procedure was repeated to obtain Cycles 2-5. Cycles 2-4 show repeatable high CO₂ capture capacity.

FIG. 2.2 illustrates that after creating PEI-UiO-66-NH₂ with 83 wt % MOF, the solution was filter dried to isolate the MOF-PEI powder. Using water-based release, the capture capacity was measured. After submerging the sample in water to release the CO₂, which was measured here by a handheld CO₂ monitor (data shown FIG. 2.2), the sample was dried again. The procedure was repeated to obtain Cycles 2-5. Cycles 2-4 show repeatable high CO₂ capture capacity.

FIG. 2.3 illustrates that after creating PEI-UiO-66-NH₂ with 74.5 wt % MOF, the solution was filter dried to isolate the MOF-PEI powder. Using water-based release, the capture capacity was measured. After submerging the sample in water to release the CO₂, which was measured here by a handheld CO₂ monitor (data shown FIG. 2.3). the sample was dried again. The procedure was repeated to obtain Cycles 2-5. Cycles 2-4 show repeatable high CO₂ capture capacity.

FIG. 2.4 illustrates that after creating PEI-UiO-66-NH₂ with 59.4 wt % MOF, the solution was filter dried to isolate the MOF-PEI powder. Using water-based release, the capture capacity was measured. After submerging the sample in water to release the CO₂, which was measured here by a handheld CO₂ monitor (data shown FIG. 2.24. the sample was dried again. The procedure was repeated to obtain Cycles 2-5.

### DETAILED DESCRIPTION

In general, the present disclosure provides for polymer-metal organic framework (polymer-MOF) composites, methods of making polymer-MOF composites, and methods of capturing CO₂. Additional details are provided herein and in the Examples.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, synthetic chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

By “chemically feasible” is meant a bonding arrangement or a compound where the generally understood rules of organic structure are not violated. The structures disclosed herein, in all of their embodiments are intended to include only “chemically feasible” structures, and any recited structures that are not chemically feasible, for example in a structure shown with variable atoms or groups, are not intended to be disclosed or claimed herein. However, if a bond appears to be intended and needs the removal of a group such as a hydrogen from a carbon, the one of skill would understand that a hydrogen could be removed to form the desired bond.

### General Discussion

The present disclosure provides for polymer-MOF composites, methods of making polymer-MOF composites, methods of capturing CO₂, direct air capture devices and systems that include the polymer-MOF composites, and the like. The polymer-MOF composites of the present disclosure can include polymers that are 100 k Daltons or more or 500 k Daltons or more within the pores of the MOF. This is advantageous since other materials can not include polymers of these molecular weights trapped within the MOF that show high carbon capture capacities (e.g., about 1 mmol CO₂/g sorbent or more (the sorbent is the polymer in the polymer-MOF composite), about 2 mmol CO₂/g sorbent or more). The polymer-MOF composites are thermally stable (e.g., stable for day, weeks, or months at temperatures over 80° C., over 90° C., over 100° C., and at 120° C.) and/or chemically stable (e.g., are substantially immiscible in water from a day to a week). In some aspects, the polymer of the polymer-MOF composite is an amine polymer or imine polymer that can be used to capture CO₂. These polymer-MOF composites can be reused for many cycles where the CO₂ is removed using water (e.g., capture CO₂, remove CO₂ from polymer-MOF composite using water, dry the polymer-MOF composite, reuse the polymer-MOF composite to capture CO₂ again). In general, the polymer-MOF composites can be used in direct air capture devices and systems to capture CO₂ and deliberately remove CO₂ from the gas stream (e.g. air, exhaust form industrial plants, exhaust from power plants, exhaust from coal plants, and the like) at a desired time. In a particular aspect, the polymer-MOF composites can be used in heating, ventilation, and air conditioning (HVAC) devices and systems to capture CO₂ and remove the CO₂. Additional details are provided below and in the Examples.

In an aspect, the present disclosure provides for polymer-MOF composites. The polymer is entrapped within pores of a metal organic framework (MOF). This occurs based on the way in which the polymer-MOF composite is formed. In short, the polymer is mixed with the precursor components needed to make the MOF. The MOF is formed in the solution that includes the polymers, so that the framework of the MOF traps polymers within the pores of the MOF. The formed polymer-MOF composite can be rinsed to remove excess polymers, while the remaining polymers are within the pores of the MOF. While portions of the polymer may not be within the pores, the pores of the MOF include large portion (e.g., 50% or more, 60% or more, 70% or more, 80% or more, 90% or more, or 95% or more) of the polymer or all of the polymer within the pores. Unlike other materials, the polymer can have larger molecular weights (e.g., 100 k Daltons or more, 200 k Daltons or more, 500K Daltons or more), which is advantageous in regard to thermal stability, chemical stability, and/or CO₂ capture. Also, the polymers having the higher molecular weights have high carbon capture capacities such as about 1 mmol CO₂/g sorbent (polymer) or more about 2 mmol CO₂/g sorbent or more, about 3 mmol CO₂/g sorbent or more, about 5 mmol CO₂/g sorbent or more, about 7 mmol CO₂/g sorbent or more, or about 10 mmol CO₂/g sorbent or more. The polymer and the precursor materials of the MOF (also referred to as “MOF components) are each miscible within a solvent (e.g., water), while the polymer-MOF composite that is formed is stable in the same solvent (e.g., water) for over 24 hours or a week. The polymer-MOF composite is thermally stable (e.g., does not deteriorate or breakdown the polymer-MOF composite into sub-components) at about 100 to 120° C. In a particular embodiment where the polymer is an amine polymer, the polymer-MOF composite can have an absorption capacity of about 2 to 14 mmol/gram of polymer-MOF composite of CO₂ or about 5 to 14 mmol/gram of polymer-MOF composite of CO₂.

In an aspect, MOFs that can be used in the polymer-MOF composite can include (zirconium MOFs (e.g., UiO-66, UiO-66 (NH₂), UiO-67, UIO-66 (COOH), UIO-68, NU-901, MOF-525, NU-1000, MOF-801, MOF-808), copper MOFs (e.g., HKUST1), iron and chromium MOFs (e.g., MIL-101 (Fe) or MIL-101 (Cr)). and zinc MOFs (e.g., ZIF-7, ZIF-8).

In an aspect, MOFs that can be used in the polymer-MOF composite can include MOFs that can be made using the following components, which also includes the MOFs listed above. In an aspect, the MOFs can be made by preparing a metal solution (e.g., a metal solution including a metal salt, an acid, and a first solvent) and a linker solution. Once the metal solution and the linker solution are prepared, the two solutions may be mixed to produce MOFs, but in this disclosure, the solutions are mixed with the polymer present to form the polymer-MOF composites and the polymer is trapped withing the pores of the MOF as the framework of the MOF is built around the polymers in a relatively fast and efficient manner. The mixing of the components to form the polymer-MOF composite can take place in a single container. In an aspect, the polymer can be mixed with one of the metal solution or the linker solution. Once the polymer is mixed with one of them, then the other can be mixed with the polymer mixture. For example, the polymer solution can be mixed with the linker solution to form a polymer-linker solution mixture, which can then be mixed with the metal solution to form the polymer-MOF composite. Thus, the various combinations can be made that finally mixed together to form the polymer-MOF composite. The various combinations can be combined as long as the ultimate polymer-MOF composite is still produced having the features as described herein.

In an aspect, the metal salt can be a zirconium salt, a zinc salt, a copper salt, an aluminum salt, an iron salt, a titanium salt, a magnesium salt, a hafnium salt, a cobalt salt, or combinations thereof. The metal salt can include: ZrOCH₂, ZrCl₄, ZrBr₄, ZrI₄, ZrO(NO₃)₂, Zr(ClO₄)₄ Zr(SO₄)₂, Zr(PO₄)₄ ZrO(CH₃COO)₂, Zr(C₆H₅O₇) (“Zirconium citrate”), Zr(CH₂C(CH₃)CO₂)₄ (“Zirconium methacrylate”), Zr(CH₂CHCO₂)₄ (“Zirconium acrylate”), Zr(OC₄H₉)₄ (“Zirconium tertbutoxide”), Zr(OCH₂CH₂CH₃)₄ (“Zirconium (IV) propoxide”). Zr₆O₄(OH)₄ (CH₂C(CH₃)CO₂)₁₂ (“Zirconium (IV) oxo hydroxy methacrylate”), Cu(NO₃)₂, CuCl, CuCl₂, CuBr, CuBr₂, CuI, CuI₂, Cu(ClO₄)₂, CuSO₄, Cu₃(PO₄)₂Cu(CH₃COO), Cu₃(C₆H₅O₇)₂ (“Copper citrate”), Cu(CH₂C(CH₃)CO₂)₂ (“Copper methacrylate”), Cu(CH₂CHCO₂)₂ (“Copper acrylate”), Cu(((CH₃)₂CHO)₂ (“Copper propoxide”), Zn(NO₃)₂, ZnCl₂, ZnBr₂, ZnI₂, Zn(ClO₄)₂, ZnSO₄, Zn₃(PO₄)₂, Zn(CH₃COO), Zn₃(C₆H₅O₇)₂ (“Zinc citrate”), Zn(CH₂C(CH)CO₂)₂ (“Zinc methacrylate”), Zn(CH₂CHCO₂)₂ (“Zinc acrylate”), Zn(OCH₂CH₂CH₃)₂ (“Zinc propoxide”), AlCh, AlBr₃, AlI₃, Al(NO₃)₃, Al(ClO₄)₃, Al₂(SO₄)₃, AlPO₄, Al(CH₃COO)₃, Al(C₆H₅O₇) (“Aluminum citrate”), Al(CH₂C(CH₃)CO₂) a (“Aluminum methacrylate”), Al(CH₂CHCO₂)₃ (“Aluminum acrylate”), Al(CH₃)₂CHO); (“Aluminum proponxide”), FeCl₂, FeCl₃, FeBr₃, FeI₂, Fe(NO₃)₂, FeSO₄, Fe₂(SO₄)₃, FePO₄, Fe(ClO₄)₂, Fe(CH₃COO)₂, Fe(C₆H₅O₇) (“Iron citrate”), Fe(CH₂C(CH₃)CO₂)₃ (“Iron methacrylate”), Fe(CH₂CHCO₂)₃ (“Iron acrylate”), Fe((CH₃)₂CHO)₃ (“Iron propoxide”), TiCl₂, TiCl₃, TiCl₄, TiBr₄, TiI₄ Ti(NO₃)₄, Ti(ClO₄)₄, Ti(SO₄)₂, Ti₃(PO₄)₄, Ti(CH₃COO)₄, Ti(C₆H₅O₇) (“Titanium citrate”), Ti(CH₂C(CH₃)CO₂)₄ (“Titanium methacrylate”), Ti(CH₂CHCO₂)₄ (“Titanium acrylate”), Ti(CH₃)₃CHO)₄ (“Titanium propoxide”). MgCl, MgBr₂, MgI₂, Mg(NO₃)₂, Mg(SO₄), Mg(PO₄)₂, Mg(ClO₄)₂, Mg(CH₃COO)₂, Mg(C₆H₅O₇) (“Magnesium citrate”), Mg(CH₂C(CH₃)CO₂)₂ (“Magnesium methacrylate”), Mg(CH₂CHCO₂)₂ (“Magnesium acrylate”), Mg((CH₃)₂CHO)₂ (“Magnesium propoxide”), HfCl₄, HfBr₄, HfI₄, Hf(NO₃)₄, Hf(SO₄)₂, Hf₃(PO₄)₄, Hf(CH₃COO)₄, Hf(C₆H₅O₇) (“Hafnium citrate”), Hf(CH₂C(CH₃)CO₂)₄ (“Hafnium methacrylate”), Hf(CH₂CHCO₂)₄ (“Hafnium acrylate”), Hf((CH₃)₂CHO)₄ (“Hafnium propoxide”), CoCl₂, CoCh, CoBr₂, CoI₂, Co(NO₃)₂, Co(ClO₄)₂, Co(SO₄), Co(CH₃COO), Co(CH₂C(CH₃)CO₂)₂ (“Cobalt methacrylate”), Co(CH₂CHCO₂)₂ (“Cobalt acrylate”), and Co((CH₃)₂CHO)₂ (“Cobalt propoxide”).

In an aspect, the acid can include a weak organic acid. The weak organic acid may be one or more monocarboxylic acids. In an aspect, the monocarboxylic acids include glycine, benzoic acid, methacrylic acid, formic acid, acetic acid, propionic acid, butyric acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, and mixtures thereof.

In an aspect, the solvent can include water, one or more polar aprotic solvents, such as N, N-dimethylformamide (“DMF”), dimethyl sulfoxide (“DMSO”), acetone, and acetonitrile, and/or one or more polar solvents, such as dichloromethane (“DCM”), tetrahydrofuran (“THF”), and ethyl acetate, or combinations thereof. In embodiments, the solvent may comprise non-polar solvents such as pentane, hexane, cyclohexane, benzene, toluene, chloroform, and diethyl ether, as well as polar protic solvents, such as ammonia, alcohols, and acetic acid, or combinations thereof.

In embodiments, the metal solution may be formed by combining at least the metal salt, the acid, and the solvent in any combination. For instance, in embodiments, the metal salt and the acid may first be mixed to form a first mixture, and the first mixture may be mixed with the first solvent to form the metal solution.

In an aspect, the linker can include an organic acid linker such as a substituted or unsubstituted, straight-chain or branched dicarboxylic acid having at least three carbon atoms and saturated and/or unsaturated C—C bonds, formula (I), formula (II), formula (III), and any combination thereof.

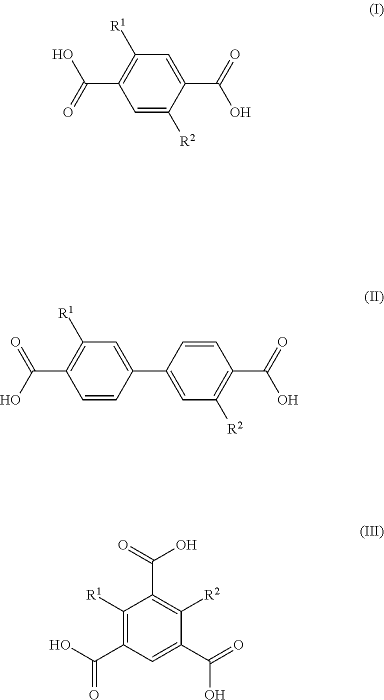

In an aspect, R¹ and R² are the same or different and are independently selected from include hydrogen, amino, sulfo, hydroxo, carboxyl, methyl, ethyl, propyl, butyl, pentyl, hexyl, heptyl, octyl, nonyl, phosphono, trifluoromethyl, trichloromethyl, or tribromomethyl.

In an aspect, the organic acid linker can include a compound having the formula (IV), formula (V), or any combination thereof.

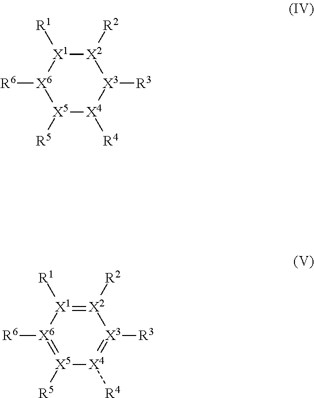

In an aspect, X¹, X², X³, X⁴, X⁵, and X⁶ are the same or different and are each independently are selected from C and N. In an aspect, R¹, R², R³, R⁴, R⁵, and R⁶ are the same or different and are each independently selected from: hydrogen, amino, sulfo, hydroxo, carboxyl, methyl, ethyl, propyl, butyl, pentyl, hexyl, heptyl, octyl, nonyl, phosphono, trifluoromethyl, trichloromethyl, tribromomethyl, 4-(carboxyphenol) benzyl, substituted or unsubstituted benzyl, and substituted or unsubstituted biphenyl. The organic acid linker can include at least two carboxyl groups.

Exemplary organic acid linkers of formula (V) can include: 1,3,5-benzenetriacetic acid (“trimesic acid”). 4,4′,4″,-Benzene-1,3,5-triyl-tris(benzoic acid), 4,4′,4″˜ (triazine-2,4,6-triyl-tris(benzene-4,1-diyl)tribenzoic acid, or 4,4′,4″-(benzene-1,3,5-triyl-tris(benzene-4,1-diyl)tribenzoic acid.

The organic acid linker can be: terephthalic acid, 2-hydroxyterephthalic acid, 2,5-dihydroxyterephthalic acid, 2-aminoterephthalic acid, 2,5-diaminoterephthalic acid, 2-sulfoterephthalic acid, 2,5-disulfoterephthalic acid, 2-methylterephthalic acid, 2,5-methylterephthalic acid, 2-phosphonoterephtahlic acid, 2,5-diphosphonoterephthalic acid, cyclohexane-1,2,4,-tricarboxylic acid, 1,2,4,5-benzenetetracarboxylic acid, cyclohexane-1,2,4,5-tetracarboxylic acid, fumaric acid, 1,4-naphthalenedicarboxylic acid, biphenyl-4,4′-dicarboxylic acid, 2-amino-4,4′-biphenyldicarboxylic acid, 2-sulfo-4,4′-biphenyldicarboxylic acid, trimesic acid, 1,3,5-cyclohexanetricarboxylic acid, 2-methylimidazole, benzimidazole, 1,3,5-benzenetrisulfonic acid, 1,4-benzenedisulfonic acid, tetraethyl 4,4′,4″,4″-(pyrene-1,3,6,8-tetrayl)tetrabenzoic acid, or any combination thereof.

These possible organic acid linkers all have the ability to be protonated or deprotonated in response to a pH of the linker solution. Thus, the organic acid linker has at least one logarithmic acid dissociation constant, i.e. at least one pKa. For instance, the MOF UIO-66 NH₂ uses 2-aminoterephthalic acid as the organic acid linker. 2-Aminoterephthalic acid is associated with a first pKa of about 3.5 and a second pKa of about 4.4. The MOF HKUST-1 uses trimesic acid as the organic acid linker, and trimesic acid is associated with three pKa values: 3.12, 3.89, and 4.70.

The linker solution can also include a base for controlling this pH. The base may be any appropriate base such as: ammonium acetate, sodium carbonate, sodium bicarbonate, dimethylamine, triethylamine, ammonium bicarbonate, disodium hydrogen phosphate, sodium chloride, sodium acetate, sodium citrate, sodium hydroxide, potassium hydroxide, potassium carbonate, potassium bicarbonate, calcium carbonate, calcium bicarbonate, or any combination thereof.

The base can be added to the linker solution to cause a pH of the linker solution to range from 5.5 to 14. For instance, the pH of the linker solution may be in the range of 6.5 to 11.5, or 7.5 to 10.5, or 8.5 to 9.5. The pH can be 5.5, 6, 6.5, 7, 7.5, 8, 8.5, 9, 9.5, 10, 10.5, 11, 11.5, 12, 12.5, 13, 13.5, 14, or any fractional part thereof.

In some embodiments, the linker solution can include a molar ratio of organic acid linker to base ranging from 1:30 to 1:0.5. For instance, this ratio may be 1:30, 1:29.5, 1:29, 1:28.5, 1:28, 1:27.5, 1:27, 1:26.5, 1:26, 1:25.5, 1:25, 1:24.5, 1:24, 1:23.5, 1:23, 1:22.5, 1:22, 1:21.5, 1:21, 1:20.5, 1:20, 1:19.5, 1:19, 1:18.5, 1:18, 1:17.5, 1:17, 1:16.5, 1:16, 1:15.5, 1:15, 1:14.5, 1:14, 1:13.5, 1:13, 1:12.5, 1:12, 1:11.5, 1:11, 1:10.5, 1:10, 1:9.5, 1:9, 1:8.5, 1:8, 1:7.5, 1:7, 1:6.5; 1:6, 1:5.5, 1:5, 1:4.5, 1:4, 1:3.5, 1:3, 1:2.5, 1:2, 1:1.5, 1:1, 1:0.5, or any fractional part thereof.

Upon mixing, the mixture may have a pH that is greater than the highest pKa of the organic acid linker. The pH of the mixture may be, for instance, 0.1 to 3 pH units greater than the highest pKa of the organic acid linker. For example, the pH of the mixture may be 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3.0, or any fractional part thereof greater than the highest pKa of the organic acid linker. This pH may, for example, range from 5 to 8 or from 5.5 to 7.5 or from 6 to 7. The pH may be, for example, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7, 1, 7.2, 7.3, 7.4, 7.5, 7.6, 7.7, 7.8, 7.9, 8, or any fractional part thereof. Without being limited to theory, achieving a mixed solution of metal solution and linker solution having a pH greater than the pKa of the organic linker was surprisingly found to increase the speed of MOF synthesis.

The metal solution and the linker solution can be mixed to form the MOF, and any MOF formed from these precursor materials can be used in the polymer-MOF composite. However, the MOFs are formed in the presence of the polymer, which will be described in more detail herein. In general, MOF synthesis, in the presence of the polymer, involves forming a metal ion cluster that then reacts with the organic acid linker to produce the MOF. A more complex metal ion cluster may require a longer synthesis time to form the ion cluster in a specific conformation. For instance, in the case of UIO-66, a hexanuclear zirconium oxocluster must be formed, although many other zirconium oxocluster species may exist, e.g. tetranuclear or zirconium ions.

As described above and herein, the MOFs are made in the presence of the polymer. Making the MOFs in the presence of the polymer allow polymers with high molecular weights to be trapped within the pores of the MOFs. This is in contrast to a situation where the MOF is formed and then the polymer is mixed with the MOF. In the latter case, larger molecular weight polymers cannot enter the pores of the MOFs unless the surface energies of the MOF and the polymer match. An advantage of the MOFs forming around the polymers is that high molecular weight polymers can be used, the polymer-MOF composite is more stable than the polymer alone or when MOFs are formed and then polymers are added according to the present disclosure, they are thermally stable (e.g., do not breakdown into sub-components parts of the polymer-MOF composite) at higher temperatures (e.g., above 90° C., about 100° C. or above 120° C.) and/or they are chemically stable (e.g., do not breakdown into sub-components parts of the polymer-MOF composite) for extended periods of time (e.g., about 24 hours, about 48 hours, about 3 day, about 4 days, about 5 days, about 6 days, about 1 week or more).

In an aspect, the selection of the MOF and polymer to form the polymer-MOF composite is based on at least the parameter that the precursor material to form the MOF (e.g., organic linker, metal ion or metal ion cluster) and polymer are both miscible in the same solvent (e.g., water). The term “miscible” does not mean that the precursor materials of the MOF and polymer are 100% miscible, rather the precursor materials of the MOF and polymer at concentrations used to make the polymer-MOF composite are miscible or substantially miscible (e.g., about 90% miscible, about 95% miscible, about 97% miscible, about 98% miscible, or about 99% miscible) in the solvent. The solvent can include water, N, N-Dimethylformamide (“DMF”), Dimethyl sulfoxide (“DMSO”), acetone, acetonitrile, dichloromethane (“DCM”), tetrahydrofuran (“THF”), ethyl acetate, pentane, hexane, cyclohexane, benzene, toluene, chloroform, diethyl ether, ammonia, alcohols, and acetic acid, or combinations thereof. In particular, the solvent is water. The polymer-MOF composite is not miscible in the solvent that the precursor material to form the MOF, and polymer are miscible in. For example, if the polymer and the precursor material to form the MOF are miscible in water, the polymer-MOF composite is not miscible in water. The phrase “not miscible” means that the polymer-MOF composite is not miscible when present in water for about 24 hours to about 1 week, about 2 days to 1 week, about 2 days to 5 days, about 3 days to 1 week, about 3 to 5 days, or about 3 to 4 days (e.g., at room temperature and up to about 120° C.).

In an aspect, the precursor materials for the MOF and the polymer are mixed together in a solvent, such as water, where the components are miscible. When the polymer and the organic linker are dissolved in water at pH 4 or above, and may be stabilized with a base, and the metal ion cluster (e.g., in this case, the Zr-oxo cluster), is created in water and stabilized with acetic acid at pH less than 7. The two solutions are mixed at room temperature and the MOF is allowed to form around the polymer to make the polymer-MOF composite. The resulting polymer-MOF composite is not miscible in the solvent.

In an aspect, the polymer can be an amine or imine polymer. The amine or imine polymer can be branched, hyperbranched, dendritic, or linear polymer. In an aspect, the amine or imine polymer can be: polyacrylamide, poly(N-isopropylacrylamide) (PNiPAM), poly(2-ethyl-2-oxazoline), polycaprolactam, poly(2-ethyl-2-oxazoline), poly(acrylamide/acrylic acid), polyacrylamide, poly(N-vinylpyrrolidone), poly(allylamine), polyethylenimine, polypropylenimine, polyvinylamine, poly(4-aminostyrene), poly(N-methylvinylamine), poly(diallyldimethylammonium chloride), poly(2-vinyl-1-methylpyridinium bromide), chitosan, poly(l-lysine hydrobromide), poly(L-lysine), polyaniline, or ploly (N-acryloyl gylcinamine), or copolymers of these. In an aspect, the polymer can be poly(allylamine), polyethylenimine, polypropylenimine, or polyvinylamine.

In an aspect, the molecular weight of the amine polymer or imine polymer can be about 30 k Daltons to 3,000,000 Daltons, about 50 k Daltons to 3,000,000 Daltons, about 100 k Daltons to 3,000,000 Daltons, about 200 k Daltons to 3,000,000 Daltons, about 500 k Daltons to 3,000,000 Daltons, about 100 k Daltons to 1,000,000 Daltons, about 200 k Daltons to 1,000,000 Daltons, or about 500 k Daltons to 1,000,000 Daltons. In an embodiment, the molecular weight is greater than 100 k Dalton, greater than about 200 k Daltons, or greater than 500 k Daltons. It may be advantageous (e.g., stability, greater CO₂ capture capacity, and the like) to have amine polymer or imine polymer that have a molecular weight of greater than 100 k Daltons (e.g., 100 k to 1,000,000 Daltons), greater than 200 k Daltons (e.g., 200 k to 1,000,000 Daltons), or greater than 500K Daltons (e.g., 500 k to 1,000,000 Daltons).

In an aspect, the polymer-MOF composite can be produced in less than 60 minutes of mixing the components, 30 minutes of mixing the components, 10 minutes of mixing the components, in less than 9 minutes of mixing the components, in less than 5 minutes of mixing the components, in less than 1 minutes of mixing the components, in less than 30 seconds of mixing the components, or in less than 15 seconds of mixing the components.

In an aspect, the polymer-MOF composite can include poly(allylamine)-zirconium MOF composites (e.g., poly(allylamine)-UiO-66, poly(allylamine)-UiO-66 (NH₂), poly(allylamine)-UiO-67, poly(allylamine)-UIO-66 (COOH), poly(allylamine)-UIO-68, poly(allylamine)-NU-901, poly(allylamine)-MOF-525, poly(allylamine)-NU-1000), poly(allylamine)-copper MOF composites (e.g., poly(allylamine)-HKUST1), and poly(allylamine)-zinc MOF composites (e.g., poly(allylamine)-ZIF-7, poly(allylamine)-ZIF-8). The poly(allylamine) can have a molecular weight of about 100K or more, about 200K or more, about 500 k or more, with the upper end being a few million Daltons.

In an aspect, the polymer-MOF composite can include polyethylenimine-zirconium MOF composites (e.g., polyethylenimine-UiO-66, polyethylenimine-UiO-66 (NH₂), polyethylenimine-UiO-67, polyethylenimine-UIO-66 (COOH), polyethylenimine-UIO-68, polyethylenimine-NU-901, polyethylenimine-MOF-525, polyethylenimine-NU-1000), polyethylenimine-copper MOF composites (e.g., polyethylenimine-HKUST1), and polyethylenimine-zinc MOF composites (e.g., polyethylenimine-ZIF-7, polyethylenimine-ZIF-8). The polyethylenimine can have a molecular weight of about 100K or more, about 200K or more, about 500 k or more, with the upper end being a few million Daltons.

In an aspect, the polymer-MOF composite can include polypropylenimine-zirconium MOF composites (e.g., polypropylenimine-UiO-66, polypropylenimine-UiO-66 (NH₂), polypropylenimine-UiO-67, polypropylenimine-UIO-66 (COOH), polypropylenimine-UIO-68, polypropylenimine-NU-901, polypropylenimine-MOF-525, polypropylenimine-NU-1000), polypropylenimine-copper MOF composites (e.g., polypropylenimine-HKUST1), and polypropylenimine-zinc MOF composites (e.g., polypropylenimine-ZIF-7, polypropylenimine-ZIF-8). The polypropylenimine can have a molecular weight of about 100K or more, about 200K or more, about 500 k or more, with the upper end being a few million Daltons.

In an aspect, the polymer-MOF composite can include polyvinylamine-zirconium MOF composites (e.g., polyvinylamine-UiO-66, polyvinylamine-UiO-66 (NH₂), polyvinylamine-UiO-67, polyvinylamine-UIO-66 (COOH), polyvinylamine-UIO-68, polyvinylamine-NU-901, polyvinylamine-MOF-525, polyvinylamine-NU-1000), polyvinylamine-copper MOF composites (e.g., polyvinylamine-HKUST1), and polyvinylamine-zinc MOF composites (e.g., polyvinylamine-ZIF-7, polyvinylamine-ZIF-8). The polyvinylamine can have a molecular weight of about 100K or more, about 200K or more, about 500 k or more, with the upper end being a few million Daltons.

In another aspect, the present disclosure provides removing CO₂ from a gas. The gas can be air or can be a gas that has a higher concentration of CO₂ (e.g., industrial exhaust, coal plant exhaust, and the like). The method includes exposing the polymer-MOF composite, as described herein, to the gas. The polymer-MOF composite captures (e.g., adsorbs) the CO₂. The CO₂ can be removed from the polymer-MOF composite by exposing the polymer-MOF composite to a solvent such as water, where the CO₂ is released into water and the polymer-MOF composite is renewed and can be reused to capture CO₂ again. In an aspect, after the polymer-MOF composite is exposed to water to remove the CO₂, the polymer-MOF composite is dried and then used. The polymer-MOF composite can capture about 3, about 5, about 8, about 10, or about 15 mmol/gram of polymer-MOF composite.

The present disclosure provides for direct air capture (DAC) systems for capturing CO₂. The DAC system includes a CO₂ capture element, where the CO₂ capture element includes the polymer-MOF composite as described herein. The polymer-MOF composite can capture CO₂ in the DAC system. In an aspect, the DAC system can be a heating, ventilation, and air conditioning (HVAC) system, where the CO₂ capture element can be a filter, CO₂ capture bed, or other structure. The CO₂ capture element can capture CO₂ for a period of time (e.g., hours, days, weeks). In particular, a portion of the polymer-MOF composite of the CO₂ capture element can be exposed to a solvent (e.g., water) to remove the captured CO₂ and then the renewed polymer-MOF composite material can then be reused to capture more CO₂. This type of cycle can be used where at least a portion of the polymer-MOF composite is exposed to the air flow and another portion is being renewed and dried for the next round of CO₂ capture. In another aspect, the DAC system includes a CO₂ removal device that can be used to remove the CO₂ by rinsing the CO₂ capture element with a solvent such as water. Various types of configurations can be used to expose a portion of polymer-MOF composite of the CO₂ capture element to air flow while another portion of the polymer-MOF composite is being rinsed and renewed. Additional details are provided in the Examples.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

We will use novel polymer-metal organic framework (MOF) materials with ultrahigh CO₂ adsorption capacity to create direct air capture (DAC) processes that can be integrated within commercial HVAC systems, among other systems. We seek to overcome the challenge of creating DAC capable materials by controlling the microstructure of the CO₂ capturing polymer-MOF sorbent. This approach allows us to utilize solid sorbent materials that are already chemically suitable for DAC, while bringing added advantages such as low cost (due to the bulk availability), controlled kinetics (by tuning transport properties) and low-temperature regeneration (by obtaining water-based CO₂ release, also known as moisture swing adsorption).

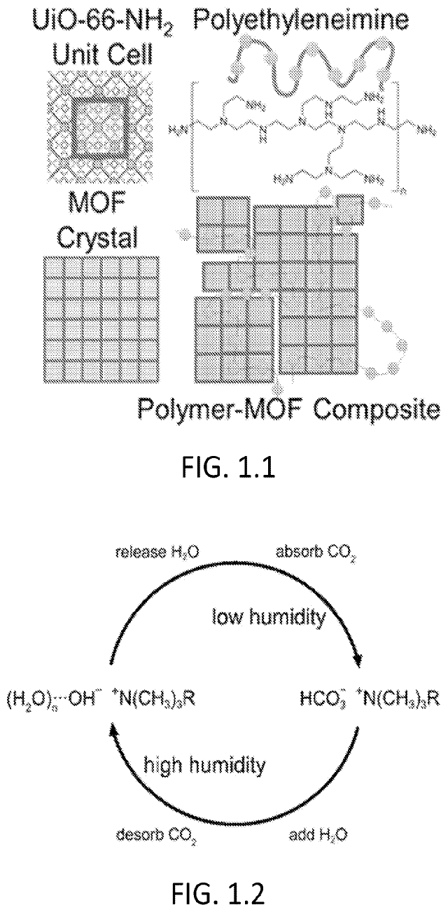

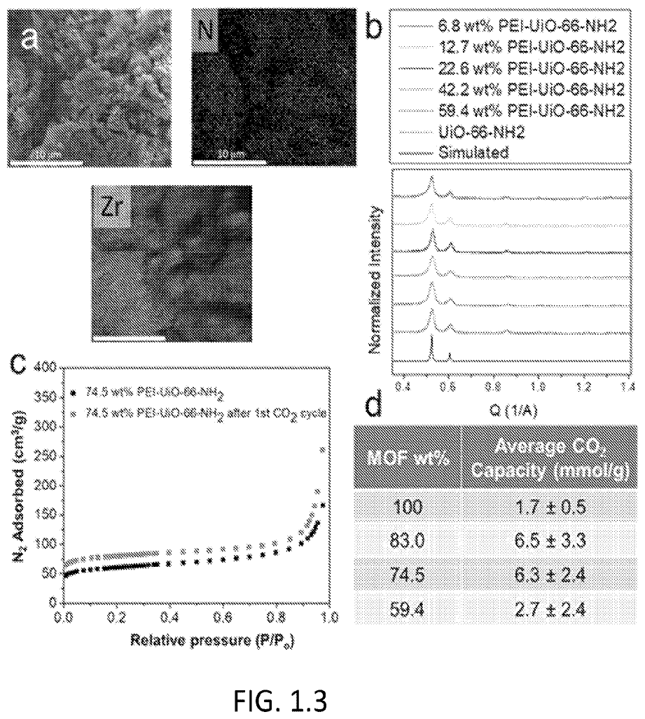

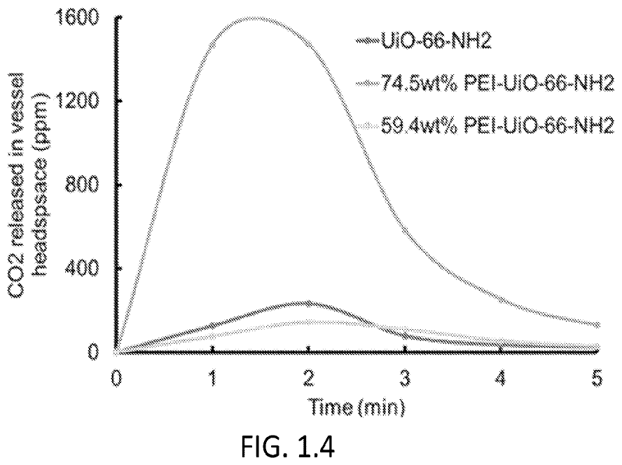

We chose the novel aminated MOF UiO-66-NH₂ and the polymer polyethyleneimine (PEI) as our prototypical DAC candidate material (FIG. 1.1). Although PEI is well known for its carbon capture properties, and has shown DAC ability, the polymer morphology is not amenable to systems level integration, due to the lack of porosity in the polymer and the instability of non-equilibrium morphologies, especially if the polymer is exposed to humid conditions or to water.² In this project, we will develop a new method to rapidly grow MOF crystals in solution while entrapping polymer chains within the crystals. This approach will create a much larger exposed amine surface area for CO₂ capture. The increased nitrogen group containing surface area will drive increased volumetric CO₂ adsorption capacity (up to 10 mmol CO₂/g sorbent), and these values are among the highest values ever achieved by solid sorbents, to the best of the authors knowledge.³⁻⁶ The ability to synthesize the composites in solution will result in the application of the composite as a washcoat solution to create systems with decreased pressure drop. Due to the high thermal and chemical stability of the UiO-66-NH₂ MOF and the trapping of the PEI polymer in the MOF crystals, we expect little capacity fade during regeneration cycles. Finally, the use of bulk commodity reagents and aqueous based synthesis is expected to result in a low-cost, scalable fabrication process while preserving green chemistry principles. We will study the potential for commercialization via talks with HVAC leaders, to understand the parameters for low-cost, low-temperature DAC processes that can be coupled with commercial HVAC systems.

The target proposed by the Carbon Negative Shot requires a fundamental shift in the development of materials for CO₂ capture and storage.⁷ Just the development of materials that can adsorb large quantities of CO₂ is not enough; these materials need to be easily integrated into systems, last through multiple regeneration cycles, and be able to be produced cheaply and in bulk quantities. A rapidly growing body of research and development is focused on CO₂ separations and enrichment to support carbon capture and storage (CCS) through direct air capture (DAC) technologies, which are approaches for actively separating CO₂ from the atmosphere.^{8,9 8,9} The challenge for DAC is that CO₂ exists in a relatively low concentration in indoor air (<1000 ppm or 0.1%), which presents a difficult separation problem.⁹ Many of the approaches that have been developed for CCS from point sources such as flue gas, which has CO₂ concentrations on the order of 10% and can benefit from existing process heat, cooling water, and may not be the best-suited approaches for removing CO₂ from ambient air.

One technology that is ubiquitous in existing and future buildings is heating, ventilation, and air conditioning (HVAC) systems.¹⁰ Indoor climate control requires the presence of HVAC systems, and in all HVAC systems temperature control and water control are available as resources. Therefore, using existing HVAC structures to obtain DAC in buildings is an exciting area of emerging applications. 11 There are a few companies that are using this idea. For example, Soletair Power is creating CO₂ capture units for indoor air, either as standalone technology or as an integrated HVAC unit. Soletair Power claims that up to 50 kg of CO₂ can be captured per day, which can be further electrocatalyzed to create fuels. In addition, a startup company Noya, promises to create HVAC units that can be integrated downstream to any existing HVAC structure, and the CO₂ is removed so that it can be sold to other manufacturers. In both cases, the technology being used to sorb the CO₂ is not public, and therefore it is difficult to understand the current state of the DAC technology for HVAC integration.

For building level DAC to be a possibility, solid sorbents are required over liquid sorbents, as solid-based sorbents are an alternative to existing liquid solvent-based separation systems that may have lower life cycle burdens. 12 These lower burdens derive primarily from the modest temperature and pressure swings that are required to recycle the sorbent, and these temperature swings (below 60° C.) are possible in HVAC systems.¹³ These solid sorbents are often made by impregnating solid support with amine functional groups.¹⁴⁻¹⁶ The solid supports are generally chosen to have mesoporosity or microporosity, to improve gas transport and increase the contact area. A number of inexpensive industrial materials can provide that support, including mesoporous silica, activated carbon, or zeolites. The mesoporosity allows for a large amount of the amine moiety to be dispersed within the solid support, which then allows for high loading of CO₂.^{14,16-19} The amine moieties can be either grafted (i.e., chemically bonded) onto sites in the support, or loaded by wet impregnation (i.e., the support material is filled with an amine solvent mixture and subsequently dried with the amine adsorbed to the walls).²⁰ All of these materials have shown DAC capability, and they have been the subject of numerous studies.^{21,22} Most of these materials have limitations that prevent it from being widely utilized for DAC applications. These limitations range from CO₂ loading capacities (best materials reach 6 mmol/g solid sorbent)^{3,23}, increased material cost due to the use of specialty chemicals, 24,25 or the requirement of multiple synthetic steps^{26,27} required to create DAC capable materials. In addition, stability of DAC capable solid sorbents are also an issue, as the physisorbed amine moieties in solid supports can be removed at high temperatures or with solvent impregnation.²⁸ In addition, most solid sorbents do not show high surface areas (>200 m²/g), which is important as higher surface areas correlate with greater CO₂ capture capacity. Finally, the microporous materials like zeolites or MOFs that are being considered for DAC can have kinetic limitations at a systems level, due to the mass transfer constraints of CO₂ transport inside the micropores.²⁹

To add to these issues, one of the biggest challenges in terms of closing the DAC loop is the regeneration of the solid sorbent. Most studies utilize temperature swing adsorption or pressure swing adsorption.⁹ One comparatively lesser-used technique is that of moisture swing adsorption, where water as a vapor (i.e. humidity), or as a liquid is used to drive CO₂ out of the sorbent during the regeneration step.³⁰ Microporous materials and ion-exchange resins can work well using moisture swing adsorption (MSA) because an equilibrium exists between the amine group that is either covalently or hydrogen-bonded to the carbon dioxide to form an associated carbamate or bicarbonate ion. The regeneration step results in the release of the carbonate/bicarbonate ion into the water, and the hydroxyl ion becomes the counterion for the aminated sorbent (FIG. 1.2).¹ Previous research has shown that the energetics of binding can be similar for CO₂ and H₂O in some sites.³¹ Armed with this knowledge, we hypothesize that water-based CO₂ desorption is possible as a regeneration step, as we expect that the excess H₂O replaces the CO₂ molecules adsorbed within some of the sorbents tested in this proposal, thus allowing for CO₂ release in the aqueous phase. We then expect to be able to dry the sorbent and prepare it for reuse using low-temperature drying processes using waste heat that is available in HVAC systems.

The prototypical technology uses PEI polymers that have already shown ability for DAC, and is produced at a bulk scale.²³ Therefore, we predict that the total cost of this technology will be lower than solid DAC sorbents that are created using specialty chemicals. In addition, the capability of PEI to perform MSA can reduce the regeneration temperature and thus lower the cost of the process by using waste heat from HVAC systems. The rapid polymer-MOF composite formation can be utilized to create a washcoat method to coat multiple processes of interests, such as packed bed and enthalpy wheels.

### Data:

Polymer-MOF Composites for DAC and MSA: The creation of novel composites that have added advantage compared to the base components would expand the material choice available for DAC and water-based release. One such class of materials are polymer-MOF composites (FIG. 1.1). Although most polymer-MOF composites are created using pre-synthesized MOFs that are suspended in a polymer matrix, these composites can be unstable towards solvents or high temperatures, due to the possibility of polymer dissolution or phase separation. We have developed a new generalizable method of making MOFs in a rapid timescale (seconds to minutes), compared to most other techniques which require MOF formation on the order of hours to days. 32 Rapid MOF synthesis opens up the possibility of trapping foreign objects, such as polymers, within the MOF structure at a high concentration, as the MOF grows around the polymer rapidly in solution (FIG. 1.1). This technique can be used with a wide variety of polymers including polyethylenimine (PEI), a polymer that has been heavily utilized for CO₂ adsorption.^{6,18,33}

Our preliminary data show that the prototypical MOF UiO-66-NH₂, which has shown carbon capture ability,³⁴ can be created as a composite with high molecular weight (>100 kDa) PEI (FIG. 1.3a). Although previous research has created low MW PEI composites with UiO-66-NH₂, which then showed enhanced CO₂ adsorption ability³⁴, here we show the formation of large MW polymer trapped in MOFs, without the need for secondary reactions. Large MW polymers within the MOF pores allows for additive interactions between the polymer and MOF pores to trap CO₂ unlike the previous composites, which chemically reacted the PEI to the MOF external surface. The polymers are well distributed within the MOF, as seen by the dispersed nature of the nitrogen elemental signature in the PEI and the zirconium elemental signature from the UiO-66 (FIG. 1.3a). For this experiment, UiO-66 was used instead of UiO-66-NH₂ to avoid nitrogen signature from the MOF linker as well. We can vary the relative concentrations of the PEI and UiO-66-NH₂ in the polymer-MOF composite, from 95 wt % PEI to 10 wt % PEI to elicit different properties. X-ray diffraction results show that the UiO-66-NH₂ MOF forms in a wide range of composites, as indicated by the diffraction from the (111) plane at q=0.5 Å-1 (FIG. 1.3b).

The surface area of a 74 wt % UiO-66-NH₂/26 wt % PEI composite showed a surface area of 250 m²/g, much lower than the pristine UiO-66-NH₂ (˜1000 m²/g), indicating that the PEI was trapped inside the MOF during crystallization (FIG. 1.3c). Even after a cycle of CO₂ adsorption, aqueous desorption, and low temperature (60° C.) regeneration, the surface area is preserved, indicating the excellent stability of the composite. Finally, total CO₂ adsorption capacity in the polymer-MOF composite (up to 9.0 mmol CO₂/g sorbent) is one of the highest values published for sorbents, to the best of the authors knowledge (FIG. 1.3d).

Water-based CO₂ Release: We also probed the ability of the polymer-MOFs to release CO₂ in an aqueous solution. The release of CO₂ in an aqueous solution from UiO-66-NH₂/PEI (75:25) and (60:40) composites was studied (FIG. 1.4). CO₂ was first adsorbed onto the polymer-MOF composite at 1 atm pressure in a closed vessel. The polymer-MOFs were loaded with CO₂ and submerged in a closed water bath, where the water was pre-equilibrated with the atmosphere to obtain water saturated with atmospheric CO₂. Any CO₂ released from the polymer-MOF composite would then be released into the headspace of the closed vessel, where a CO₂ meter monitored the increase in CO₂ concentration. We see that within minutes, CO₂ concentration in the headspace increases by 1600 ppm CO₂/g sorbent for the 75:25 UiO-66-NH₂/PEI composite, showing that aqueous release of CO₂ is possible from the polymer-MOF composites (FIG. 1.4). The amount of CO₂ released from the polymer-MOF is also dependent on the exact composition of the polymer-MOF; polymer-MOF composites with a lower surface area (60:40 UiO-66-NH₂/PEI) showed a lower total change in concentration of CO₂. Only the 75:25 UiO-66-NH₂/PEI composites show a higher change in CO₂ concentration compared to the UiO-66-NH₂ control, or the PEI control (not shown), showing that the polymer concentration within the MOF needs to be tuned to obtain groundbreaking performance.

These preliminary data indicate we have obtained groundbreaking CO₂ capture performance in our UiO-66-NH₂/PEI composites. This, with knowledge from literature that PEI can be used for DAC, shows that we have created a champion material for DAC. This composite is different from traditional mixed matrix membranes which utilize pre-formed MOF crystals, as the polymers are trapped within the MOFs. Due to this trapping, these composites are stable being exposed to humid or aqueous conditions, and can be easily regenerated through low temperature (60° C.) drying. The composite can be regenerated to the same surface area by driving out the water by increasing the temperature to 60° C.

Therefore, this technology can be utilized to obtain innovative DAC across multiple fronts. We have created an advanced polymer-MOF composites to obtain increased CO₂ loading, where the polymer PEI is DAC capable, and without having to utilizing specialty materials. As these composites can be created in solution within minutes, washcoat compositions can be created to coat multiple type of supports. In this proposal, we will use machine learning technologies to integrate the composite into various systems to create low-pressure drop, cost effective supports, while also reducing the power required to capture CO₂ and regenerate the composite. We show that rapid regeneration of the material is possible using MSA followed by low temperature water desorption. Finally, the high CO₂ loading possible in the composite compared to any other sorbent developed until now indicates that processes with reduced footprint can be created that can interface HVAC systems.

True density estimation based on the addition of polymers PEI into the UiO-66-NH₂ pores. The mass of the material will increase while the volume will remain the same. Bulk density is measured and is expected to stay the same. Average particle diameter can be controlled by controlling the MOF crystallization kinetics, and will depend on the optimal packed bed and enthalpy wheel morphology. Packing density is extremely high due to the high internal surface area present in our composites, and controlling MOF crystallization is expected to make this even higher. Heat capacity in mesoporous silica impregnated with PEI is similar to that of the support. We expect the heat capacity of the UiO-66-NH₂ to be the capacity of the polymer-MOF as well.

All adsorption is expected to occur at 1 bar and room temperature. CO₂ adsorption is currently only measured at 1 atm, but shows record high values for PEI based systems. The cited literature shows that for high MW PEI polymer, there is a factor of 3 reduction in CO₂ capture capacity between 1 atm CO₂ and DAC.^{3,4} We expect the same result for our system, since the mode of CO₂ capture is the same.

Desorption occurs in water at room temperature at 1 atm currently. For higher solubility this can be increased up to 50 atm. No CO₂ is seen left in sample after deloading. Heat of desorption currently unknown due to water-based release of CO₂. Rapid release of CO₂ in water is observed (FIG. 1.4).

The research utilizes PEI, a polymer that has shown to achieve DAC, and increases the accessible surface area by trapping PEI chains within the UiO-66-NH₂ MOF. Therefore, we do not need to change the chemistry of a known material, and instead we control the crystallization of the MOF to increase CO₂ adsorption capacity, adsorption and desorption kinetics, and preserve the polymer-MOF composite stability. The choice of PEI allows for MSA, which lowers the energy and temperature requirement for regeneration of the sorbent. This system can be created in a continuous flow-based system so that integration into packed beds and enthalpy wheels are possible, and the process of DAC followed by desorption will be engineered such that inclusion of the system in a commercial HVAC process is possible.

### REFERENCES

(1) Yang, H.; Singh, M.; Schaefer, J. Humidity-swing mechanism for CO₂ capture from ambient air. Chemical Communications 2018, 54, 4915-4918.
(2) Pastore, V. J.; Cook, T. R.; Rzayev, J. Polymer-MOF Hybrid Composites with High Porosity and Stability through Surface-Selective Ligand Exchange. Chemistry of Materials 2018, 30, 8639-8649.
(3) Xu, X.; Pejcic, B.; Heath, C.; Myers, M. B.; Doherty, C.; Gozukara, Y.; Wood, C. D. Polyethylenimine “Snow”: An Emerging Material for Efficient Carbon Removal. ACS Applied Materials & Interfaces 2019, 11, 26770-26780.
(4) Xu, X.; Myers, M. B.; Versteeg, F. G.; Pejcic, B.; Heath, C.; Wood, C. D. Direct air capture (DAC) of CO 2 using polyethylenimine (PEI) “snow”: a scalable strategy. Chemical Communications 2020, 56, 7151-7154.
(5) Wang, W.; Li, J.; Wei, X.; Ding, J.; Feng, H.; Yan, J.; Yang, J. Carbon dioxide adsorption thermodynamics and mechanisms on MCM-41 supported polyethylenimine prepared by wet impregnation method. Applied Energy 2015, 142, 221-228.
(6) Zhao, J.; Simeon, F.; Wang, Y.; Luo, G.; Hatton, T. A. Polyethylenimine-impregnated siliceous mesocellular foam particles as high capacity CO₂ adsorbents. RSC Advances 2012, 2, 6509-6519.
(7) PUES, D. DIRECT AIR CAPTURE. 2022.
(8) Shabbani, H. J. K. A Review of CO₂ Adsorption From Ambient Air (Direct Air Capture). Al-Qadisiyah Journal for Engineering Sciences 2020, 13, 01-06.
(9) McQueen, N.; Gomes, K. V.; McCormick, C.; Blumanthal, K.; Pisciotta, M.; Wilcox, J. A review of direct air capture (DAC): scaling up commercial technologies and innovating for the future. Progress in Energy 2021.
(10) Handbook, A.: HVAC systems and equipment; chapter, 1996; Vol. 39.
(11) Baus, L.; Nehr, S. Potentials and limitations of direct air capturing in the built environment. Building and Environment 2022, 208, 108629.
(12) Gebald, C.; Wurzbacher, J. A.; Tingaut, P.; Zimmermann, T.; Steinfeld, A. Amine-based nanofibrillated cellulose as adsorbent for CO₂ capture from air. Environmental science & technology 2011, 45, 9101-9108.
(13) Choi, S.; Drese, J. H.; Eisenberger, P. M.; Jones, C. W. Application of amine-tethered solid sorbents for direct CO₂ capture from the ambient air. Environmental science & technology 2011, 45, 2420-2427.
(14) Anyanwu, J.-T.; Wang, Y.; Yang, R. T. Amine-Grafted Silica Gels for CO₂ Capture Including Direct Air Capture. Industrial & Engineering Chemistry Research 2020, 59, 7072-7079.
(15) Choi, W.; Park, J.; Kim, C.; Choi, M. Structural effects of amine polymers on stability and energy efficiency of adsorbents in post-combustion CO₂capture. Chemical Engineering Journal 2021, 408, 127289.
(16) Wang, J.; Wang, M.; Li, W.; Qiao, W.; Long, D.; Ling, L. Application of polyethylenimine-impregnated solid adsorbents for direct capture of low-concentration CO₂. AlChE Journal 2015, 61, 972-980.
(17) Lu, W.; Sculley, J. P.; Yuan, D.; Krishna, R.; Zhou, H.-C. Carbon dioxide capture from air using amine-grafted porous polymer networks. The Journal of Physical Chemistry C 2013, 117, 4057-4061.
(18) Zhang, W.; Liu, H.; Sun, C.; Drage, T. C.; Snape, C. E. Capturing CO₂ from ambient air using a polyethyleneimine-silica adsorbent in fluidized beds. Chemical Engineering Science 2014, 116, 306-316.
(19) Sayari, A.; Liu, Q.; Mishra, P. Enhanced Adsorption Efficiency through Materials Design for Direct Air Capture over Supported Polyethylenimine. ChemSusChem 2016, 9, 2796-2803.
(20) Martín, C. F.; Sweatman, M. B.; Brandani, S.; Fan, X. Wet impregnation of a commercial low cost silica using DETA for a fast post-combustion CO₂ capture process. Applied Energy 2016, 183, 1705-1721.
(21) Custelcean, R. Direct air capture of CO2 via crystal engineering. Chemical Science 2021, 12, 12518-12528.
(22) Kumar, A.; Madden, D. G.; Lusi, M.; Chen, K. J.; Daniels, E. A.; Curtin, T.; Perry IV, J. J.; Zaworotko, M. J. Direct air capture of CO₂ by physisorbent materials. Angewandte Chemie International Edition 2015, 54, 14372-14377.
(23) Shen, X.; Du, H.; Mullins, R. H.; Kommalapati, R. R. Polyethylenimine Applications in Carbon Dioxide Capture and Separation: From Theoretical Study to Experimental Work. Energy Technology 2017, 5, 822-833.
(24) Lai, J. Y.; Ngu, L. H.; Hashim, S. S. A review of CO₂ adsorbents performance for different carbon capture technology processes conditions. Greenhouse Gases: Science and Technology 2021, 11, 1076-1117.
(25) Mello, M. R.; Phanon, D.; Silveira, G. Q.; Llewellyn, P. L.; Ronconi, C. M. Amine-modified MCM-41 mesoporous silica for carbon dioxide capture. Microporous and Mesoporous Materials 2011, 143, 174-179.
(26) Sanz-Peréz, E. S.; Arencibia, A.; Sanz, R.; Calleja, G. New developments on carbon dioxide capture using amine-impregnated silicas. Adsorption 2016, 22, 609-619.
(27) Li, T.; Pan, Y.; Peinemann, K.-V.; Lai, Z. Carbon dioxide selective mixed matrix composite membrane containing ZIF-7 nano-fillers. Journal of Membrane Science 2013, 425-426, 235-242.
(28) Deng, Y.; Li, J.; Miao, Y.; Izikowitz, D. A comparative review of performance of nanomaterials for Direct Air Capture. Energy Reports 2021, 7, 3506-3516.
(29) Heinke, L. Diffusion and photoswitching in nanoporous thin films of metal-organic frameworks. Journal of Physics D: Applied Physics 2017, 50, 193004.
(30) Shi, X.; Xiao, H.; Kanamori, K.; Yonezu, A.; Lackner, K. S.; Chen, X. Moisture-Driven CO₂ Sorbents. Joule 2020, 4, 1823-1837.
(31) Wang, T.; Lackner, K. S.; Wright, A. B. Moisture-swing sorption for carbon dioxide capture from ambient air: a thermodynamic analysis. Physical Chemistry Chemical Physics 2013, 15, 504-514.
(32) Huelsenbeck, L.; Luo, H.; Verma, P.; Dane, J.; Ho, R.; Beyer, E.; Hall, H.; Geise, G. M.; Giri, G. Generalized Approach for Rapid Aqueous MOF Synthesis by Controlling Solution pH. Crystal Growth & Design 2020, 20, 6787-6795.
(33) Lin, Y.; Yan, Q.; Kong, C.; Chen, L. Polyethyleneimine Incorporated Metal-Organic Frameworks Adsorbent for Highly Selective CO₂ Capture. Scientific Reports 2013, 3, 1859.
(34) Zhu, J.; Wu, L.; Bu, Z.; Jie, S.; Li, B.-G. Polyethyleneimine-Modified UiO-66-NH₂ (Zr) Metal-Organic Frameworks: Preparation and Enhanced CO₂ Selective Adsorption. ACS Omega 2019, 4, 3188-3197.
(35) Bambalaza, S. E.; Langmi, H. W.; Mokaya, R.; Musyoka, N. M.; Ren, J.; Khotseng, L. E. Compaction of a zirconium metal-organic framework (UiO-66) for high density hydrogen storage applications. Journal of Materials Chemistry A 2018, 6, 23569-23577.
(36) Mu, B.; Walton, K. S. Thermal Analysis and Heat Capacity Study of Metal-Organic Frameworks. The Journal of Physical Chemistry C 2011, 115, 22748-22754.
(37) Su, Z.; Miao, Y.-R.; Zhang, G.; Miller, J. T.; Suslick, K. S. Bond breakage under pressure in a metal organic framework. Chemical Science 2017, 8, 8004-8011.
(38) Wieme, J.; Vandenbrande, S.; Lamaire, A.; Kapil, V.; Vanduyfhuys, L.; Van Speybroeck, V. Thermal Engineering of Metal-Organic Frameworks for Adsorption Applications: A Molecular Simulation Perspective. ACS Applied Materials & Interfaces 2019, 11, 38697-38707.
(39) Gelles, T.; Lawson, S.; Rownaghi, A. A.; Rezaei, F. Recent advances in development of amine functionalized adsorbents for CO₂ capture. Adsorption 2020, 26, 5-50.

### Example 2

### Materials:

Zirconyl chloride octahydrate (ZrOCl₂·8H₂O, 98%), acetic acid (glacial, ≥99.7%), sodium hydroxide (NaOH, ≥98%), 2-aminoterephthalic acid (H₂ATA, 99%), and polyethyleneimine (PEI, M_{w}˜750,000, 50 wt % in H₂O) were purchased from Sigma-Aldrich. PEI solution was diluted with deionized water (DI) to reach a concentration of 25 wt %. Carbon dioxide (CO₂, ≥99.7%) tank was purchased from Linde.

### Synthesis of UiO-66-NH₂:

To make UiO-66-NH₂, 1.81 g of H₂ATA and 0.8 g of NaOH were added to 50 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and UiO-66-NH₂ powder was obtained.

Synthesis of PEI-UiO-66-NH₂ Containing 83 wt % of UiO-66-NH₂ (Denoted as 83 wt % PEI-UiO-66-NH₂):

To create 83.0 wt % PEI-UiO-66-NH₂, 1.81 g of H₂ATA, 0.8 g of NaOH, and 0.6 mL of PEI (25 wt % in H₂O) were added to 49.4 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 83 wt % PEI-UiO-66-NH₂ powder was obtained. Synthesis of PEI-UiO-66-NH₂ containing 74.5 wt % of UiO-66-NH₂ (denoted as 74.5 wt % PEI-UiO-66-NH₂):

To create 74.5 wt % PEI-UiO-66-NH₂, 1.81 g of H₂ATA, 0.8 g of NaOH, and 1.0 ml of PEI (25 wt % in H₂O) were added to 49.0 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 74.5 wt % PEI-UiO-66-NH₂ powder was obtained.

Synthesis of PEI-UiO-66-NH₂ Containing 59.4 wt % of UiO-66-NH₂ (Denoted as 59.4 wt % PEI-UiO-66-NH₂):

To create 59.4 wt % PEI-UiO-66-NH₂, 1.81 g of H₂ATA, 0.8 g of NaOH, and 2.0 mL of PEI (25 wt % in H₂O) were added to 48.0 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 59.4 wt % PEI-UiO-66-NH₂ powder was obtained.

Synthesis of PEI-UiO-66-NH₂ Containing 42.2 wt % of UiO-66-NH₂ (Denoted as 42.2 wt % PEI-UiO-66-NH₂):

To create 42.2 wt % PEI-UiO-66-NH₂, 1.81 g of H₂ATA, 0.8 g of NaOH, and 4.0 mL of PEI (25 wt % in H₂O) were added to 46.0 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 42.2 wt % PEI-UiO-66-NH₂ powder was obtained.

Synthesis of PEI-UiO-66-NH₂ Containing 22.6 wt % of UiO-66-NH₂ (Denoted as 22.6 wt % PEI-UiO-66-NH₂):

To create 22.6 wt % PEI-UiO-66-NH₂, 1.81 g of H₂ATA, 0.8 g of NaOH, and 10.0 mL of PEI (25 wt % in H₂O) were added to 40.0 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 22.6 wt % PEI-UiO-66-NH₂ powder was obtained.

Synthesis of PEI-UiO-66-NH₂ Containing 12.7 wt % of UiO-66-NH₂ (Denoted as 12.7 wt % PEI-UiO-66-NH₂):

To create 12.7 wt % PEI-UiO-66-NH₂, 1.81 g of H₂ATA, 0.8 g of NaOH, and 20.0 mL of PEI (25 wt % in H₂O) were added to 30.0 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 12.7 wt % PEI-UiO-66-NH₂ powder was obtained.

Synthesis of PEI-UiO-66-NH₂ Containing 6.8 wt % of UiO-66-NH₂ (Denoted as 6.8 wt % PEI-UiO-66-NH₂):

To create 6.8 wt % PEI-UiO-66-NH₂, 1.81 g of H₂ATA, 0.8 g of NaOH, and 40.0 ml of PEI (25 wt % in H₂O) were added to 10.0 mL of DI water to prepare the linker solution. Metal-oxo cluster solution was prepared by dissolving 3.864 g of ZrOCl₂·8H₂O in a solution of 15 mL acetic acid and 36 mL DI water followed by heating at 70° C. for 2 h. The metal-oxo cluster solution was cooled down to room temperature. Then, 50 mL of the metal-oxo cluster solution was added to the 50 mL of linker solution and stirred for 24 h. After 24 h, the solution was dried at room temperature and 6.8 wt % PEI-UiO-66-NH₂ powder was obtained.

### Carbon Dioxide (CO₂) Sorption:

Before treatment with CO₂, the dried PEI-UiO-66-NH₂ was heated at 60° C. in a vacuum oven for 24 hours. The composite was then transferred to a 250 mL Erlenmeyer flask. The flask was flushed with CO₂ for 4-5 minutes, stoppered, and allowed to sit for 24 hours.

To desorb CO₂ from the PEI-UiO-66-NH₂, 30 mL DI water was added to a 250 ml filtering flask. A CO₂ sensor was attached to the sidearm to measure CO₂ desorption. DI water was stirred for 10-20 minutes to allow the CO₂ sensor to equilibrate. CO₂ treated PEI-UiO-66-NH₂ composite was then quickly added and the filtering flask was stoppered to track CO₂ levels. Carbon dioxide levels were monitored until the sensor stabilized. The resulting solution left in the flask was poured into a Teflon dish to air dry and heated at 60° C. in a vacuum oven to repeat the same sorption experiment. Each sample was repeated up to 5 cycles.

### High Capacity, Water Release and Cyclability of PEI-UiO-66-NH₂ Composites:

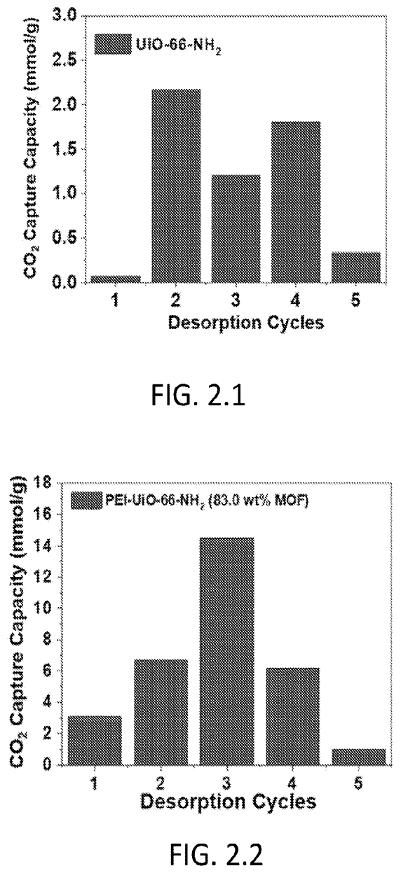

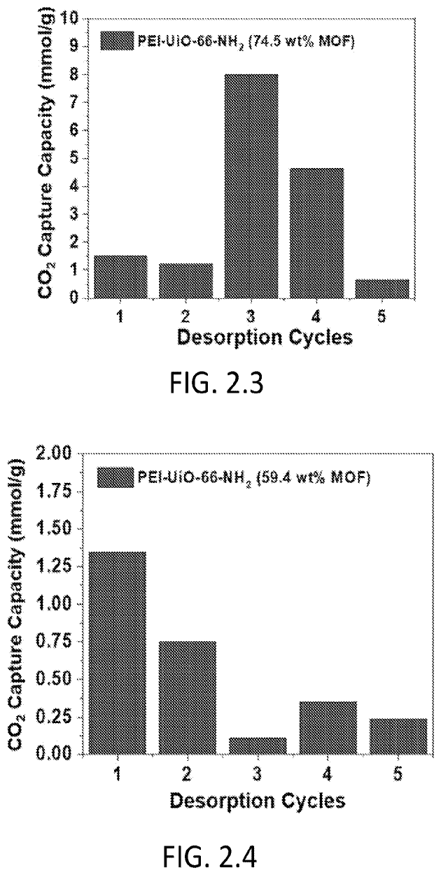

The synthesized PEI-UiO-66-NH₂ composites containing different wt % of MOFs show high CO₂ loading capacity as suggested by the water release. For these experiments, we put the PEI-UiO-66-NH₂ composite under pure CO₂ environment for 24 h. After 24 h, we put the composite in the water and measured the desorbed CO₂ using a CO₂ reader, which shows the increase in CO₂ ppm level upon addition of the composite to the water. Based on the increased CO₂ ppm level, we calculated the amount of CO₂ released by the composite. We measured the CO₂ capacity of these composited up to 5 cycles. FIGS. 2.1-2.4 illustrate the capture capacity as a function of desorption cycles.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A polymer-metal organic framework (polymer-MOF) composite, comprising:
a polymer entrapped within pores of a metal organic framework (MOF), wherein the MOF is formed from precursor materials,
wherein the polymer has a molecular weight of about 30 k Daltons to 3,000,000 Daltons, wherein the polymer and precursor materials that are used to form the MOF are each miscible within a first solvent, wherein the polymer-MOF composite is stable in the first solvent for about 24 hours or more,
wherein the polymer-MOF composite is thermally stable at about 100 to 120° C., and
wherein the polymer-MOF composite has the absorption capacity of about 2 to 14 mmol/gram of polymer-MOF composite of CO₂.

2. The polymer-MOF composite of claim 1, wherein the polymer has a molecular weight of about 100 k Daltons to 3,000,000 Daltons.

3. The polymer-MOF composite of claim 1, wherein the polymer has a molecular weight of about 200 k Daltons to 3,000,000 Daltons.

4. The polymer-MOF composite of claim 1, wherein the polymer has a molecular weight of about 500 k Daltons to 3,000,000 Daltons.

5. The polymer-MOF composite of claim 1, wherein the first solvent is water.

6. The polymer-MOF composite of claim 5, wherein the polymer-MOF composite is thermally stable at about 120° C.

7. The polymer-MOF composite of claim 1, wherein the polymer is an amine polymer.

8. The polymer-MOF composite of claim 7, wherein amine or imine polymer is selected from the group consisting of: a polyacrylamide, poly(N-isopropylacrylamide) (PNiPAM), poly(2-ethyl-2-oxazoline), polycaprolactam, poly(2-ethyl-2-oxazoline), poly(acrylamide/acrylic acid), polyacrylamide, poly(N-vinylpyrrolidone), poly(allylamine), polyethylenimine, polypropylenimine, polyvinylamine, poly(4-aminostyrene), poly(N-methylvinylamine), poly(diallyldimethylammonium chloride), poly(2-vinyl-1-methylpyridinium bromide), chitosan, poly(l-lysine hydrobromide), poly(L-lysine), polyaniline, and ploly(N-acryloyl gylcinamine).

9. The polymer-MOF composite of claim 18, wherein amine polymer is selected from the group consisting of: poly(allylamine), polyethylenimine, polypropylenimine, and polyvinylamine.

10. The polymer-MOF composite of claim 8, wherein the amine polymer is branched, hyperbranched, dendritic, or linear.

11. A polymer-metal organic framework (polymer-MOF) composite, comprising: a polymer entrapped within pores of a metal organic framework (MOF), wherein the MOF is made of precursor materials, wherein the polymer has a molecular weight of about 30 k Daltons to 3,000,000 Daltons,
wherein the polymer and the precursor materials that form the MOF are each miscible within a first solvent, wherein the polymer-MOF composite is stable in the first solvent for about 24 hours or more, and
wherein the polymer-MOF composite is thermally stable at about 100 to 120° C.

12. The polymer-MOF composite of claim 11, wherein the polymer is selected from the group consisting of: polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl) thieno[3,2-b]thiophene], poly[2,5-bis(3-dodecylthiophen-2-yl) thieno[3,2-b]thiophene], poly[2,5-bis(3-hexadecylthiophen-2-yl) thieno[3,2-b]thiophene], poly[2,5-bis(3-octadecylthiophen-2-yl) thieno[3,2-b]thiophene], polythiophene, polytetrafluoroethylene, poly(perfluoro-3,6-dioxa-4-methyl-7-octene-sulfonic acid), co-polymers thereof, and combinations thereof.

13. The polymer-MOF composite of claim 11, wherein the polymer has a molecular weight of about 100 k Daltons to 3,000,000 Daltons.

14. The polymer-MOF composite of claim 11, wherein the polymer has a molecular weight of about 200 k Daltons to 3,000,000 Daltons.

15. The polymer-MOF composite of claim 11, wherein the polymer has a molecular weight of about 500 k Daltons to 3,000,000 Daltons.

16. The polymer-MOF composite of claim 11, wherein the first solvent is water.

17. The polymer-MOF composite of claim 11, wherein the polymer-MOF composite is thermally stable at about 120° C.

18. The polymer-MOF composite of claim 1, wherein the polymer is an amine polymer.

19. (canceled)

20. The polymer-MOF composite of claim 18, wherein amine polymer is selected from the group consisting of: poly(allylamine), polyethylenimine, polypropylenimine, and polyvinylamine.

21. (canceled)

22. A direct air capture (DAC) system, comprising a CO₂ capture element, wherein the CO₂ capture element includes the polymer-MOF composite of claim 1.

23-26. (canceled)
